(19) United States
(12) Patent Application Publication
(10) Pub. No.: US 2018/0039893 A1
(43) Pub. Date: Feb. 8, 2018

(54) TOPIC-BASED TEAM ANALYTICS ENHANCEMENT

(71) Applicant: International Business Machines Corporation, Armonk, NY (US)

(72) Inventors: Paul R. Bastide, Boxford, MA (US); Shu Qiang Li, Beijing (CN); Na Pei, Beijing (CN); Pei Sun, Beijing (CN); Lei Wang, Beijing (CN)

(21) Appl. No.: 15/230,572

(22) Filed: Aug. 8, 2016

(51) Int. Cl. G06N 5/04; H04L 12/58; G06F 17/30

(52) U.S. Cl. CPC G06N 5/04; G06F 17/30958; H04L 51/046

(57) ABSTRACT

In an approach to topic-based team analytics, a computing device extracts a list of topics based on a thread. The computing device identifies one or more participants with a relationship to one or more topics of the list of topics. The computing device generates a graph of the list of topics, the one or more participants, and relationships of the one or more participants to the one or more topics, wherein the one or more participants are represented as participant nodes of the graph and the one or more topics are represented as topic nodes of the graph, and wherein the relationships of the one or more participants to the one or more topics are represented as one or more edges connecting participant nodes with topic nodes.

### TECHNICAL FIELD OF THE INVENTION

The present disclosure relates generally to data analytics, and more particularly to analysis of relationships among participants in a conversation.

### BACKGROUND OF THE INVENTION

Email is an important tool for communication and problem solving. The sender of an email message often sends the message to several recipients in order to discuss a topic. A recipient of the message may send a reply to all of the other recipients in order to provide his or her opinion on the matter. The original message, the reply, and succeeding replies from the other recipients generate an email thread (also commonly referred to as a “conversation”).

Sometimes, a complex email thread may be generated when new recipients (i.e., recipients not privy to the original message) are sent succeeding replies in the thread. The new recipients may need to read multiple messages in the thread in order to bring themselves up-to-date on the discussion.

Conventional technology allows an email recipient to extract user identities from a thread and generate a graph representing direct and indirect connections among the users. The number of users represented may be limited in order to produce a graph that allows the email recipient to orient him or herself more quickly in the discussion.

### SUMMARY

According to one embodiment of the present invention, a computer-implemented method for, a computer program product, and/or a computer system is provided. A computing device extracts a list of topics based on a thread. The computing device identifies one or more participants with a relationship to one or more topics of the list of topics. The computing device generates a graph of the list of topics, the one or more participants, and relationships of the one or more participants to the one or more topics, wherein the one or more participants are represented as participant nodes of the graph and the one or more topics are represented as topic nodes of the graph, and wherein the relationships of the one or more participants to the one or more topics are represented as one or more edges connecting participant nodes with topic nodes.

### BRIEF DESCRIPTION OF THE DRAWINGS

FIGS. 1A-B are a block diagram of an exemplary computing environment and modules of a topic-based team analytics program in the exemplary computing environment, in accordance with an embodiment of the present invention;

FIG. 2 is a flowchart depicting operational steps of a topic-based team analytics method, in accordance with an embodiment of the present invention;

FIGS. 3A-F are diagrams illustrating an example of topic-based team analytics, in accordance with an embodiment of present invention; and

FIG. 4 is a block diagram of components of the computing device in FIG. 1 executing a topic-based team analytics program, in accordance with an embodiment of the present invention.

### DETAILED DESCRIPTION

Embodiments described herein provide methods, computer program products, and/or computer systems that enable organization and presentation of relationships among participants and topics in an email thread based on extracting dynamic relationship information from message content.

Embodiments of the present invention may recognize one or more of the following facts, potential problems, potential scenarios, and/or potential areas for improvement with respect to the current state of the art: (i) an email recipient may not be acquainted with any, or all but one or a few, of the senders in a thread and have little connection with any of the senders; (ii) in a very long thread, the email recipient may not have time to read through various individual messages to get a sense of the discussion; and/or (iii) conventional filters that may be used to handle activity stream overload require user specification of an author, title, keyword, and/or time.

Embodiments of the present invention may include one or more of the following features, characteristics, and/or advantages: (i) extraction of topics from message content; (ii) identification of participants in a thread; (iii) connection of topics with related participants; (iv) generation and presentation of a participant-topic relationship graph; (v) presentation of summary information regarding participant-topic relationships; and/or (vi) filtering of a participant-topic relationship graph to focus on the relationships of various participants to one topic.

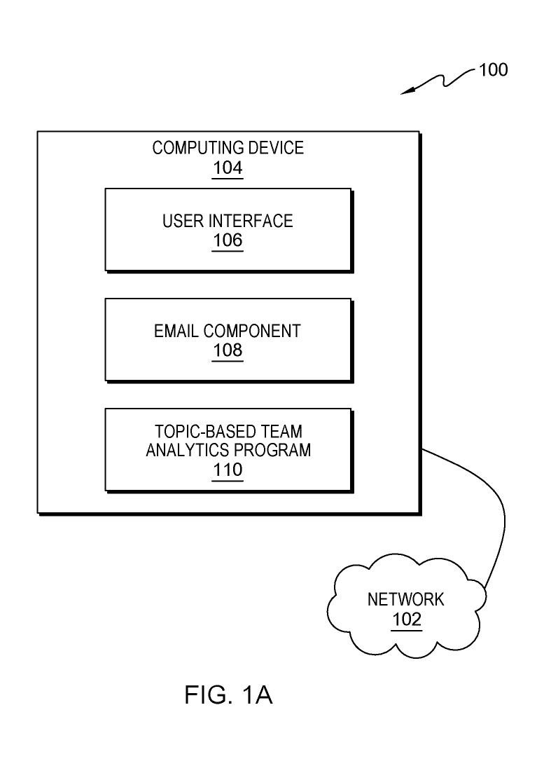

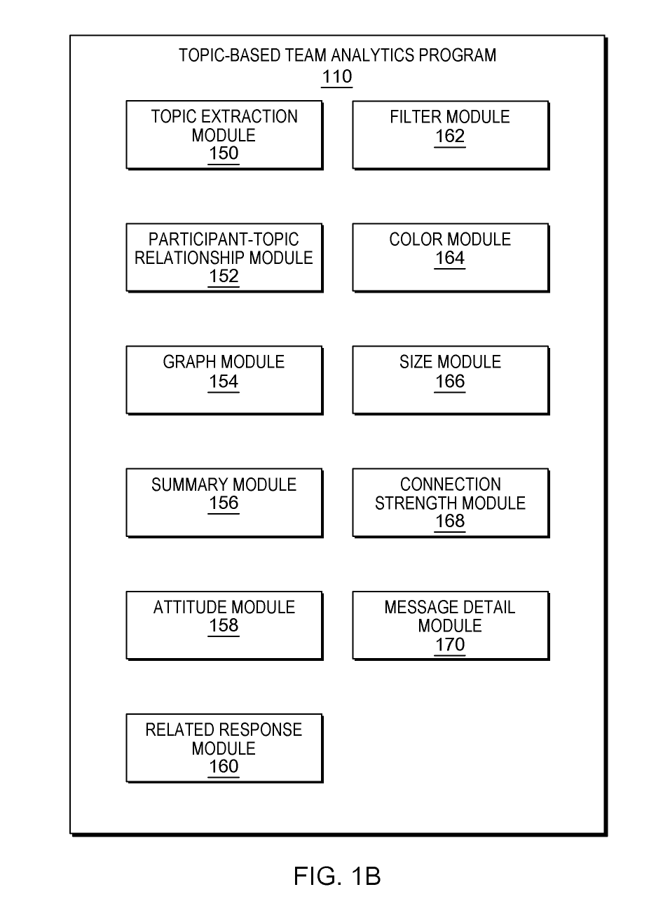

Embodiments of the present invention are described herein with reference to the Figures. FIG. 1A shows a block diagram of a computing environment 100, in accordance with an embodiment of the present invention. FIG. 1A is provided for the purposes of illustration and does not imply any limitations with regard to the environments in which different embodiments can be implemented. Modifications to the depicted environment can be made by those skilled in the art without departing from the scope of the invention as recited in the claims.

Computing environment 100 includes computing device 104, which can be interconnected with other devices (not shown) over network 102. Network 102 can be, for example, a telecommunications network, a local area network (LAN), a wide area network (WAN), such as the Internet, or a combination of these, and can include wired, wireless, or fiber optic connections. In general, network 102 can be any combination of connections and protocols that will support communications between computing device 104 and other computing devices (not shown) within computing environment 100.

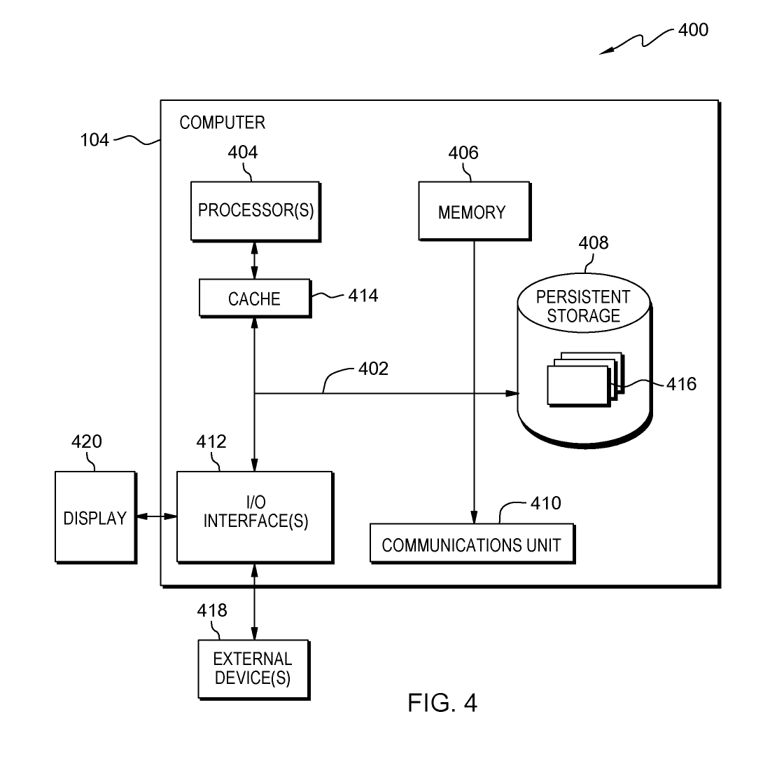

Computing device 104 can be any programmable electronic device or combination of devices capable of executing machine-readable instructions and communicating with other devices over network 102. Computing device 104 includes user interface 106, email component 108, and topic-based team analytics program 110. Computing device 104 can include internal and external hardware components, as depicted and described in further detail with reference to FIG. 4.

User interface 106 provides an interface between a user of computing device 104 and computing device 104. User interface 106 can be, but is not limited to being, a graphical user interface (GUI) or a web user interface (WUI) and can display text, documents, web browser windows, user options, application interfaces, and instructions for operation, and can include the information (such as graphic, text, and sound) presented to a user and the control sequences the user employs to control email component 108 and topic-based team analytics program 110.

Email component 108 can be any device or software configured to send, receive, and/or access remotely stored email messages across network 102. A user (not illustrated) may use email component 108 to send and receive messages comprising an email thread, which may be analyzed by topic-based team analytics program 110.

FIG. 1B shows components of topic-based team analytics program 110, in accordance with an embodiment of the present invention. Topic-based team analytics program 110 may include topic extraction module (“mod”) 150, participant-topic relationship module (“mod”) 152, graph module (“mod”) 154, summary module (“mod”) 156, attitude module (“mod”) 158, related response module (“mod”) 160, filter module (“mod”) 162, color module (“mod”) 164, size module (“mod”) 166, connection strength module (“mod”) 168, and message detail module (“mod”) 170. Embodiments may include fewer than all mods 150-170.

Mod 150 generates topics based on message content. In a non-limiting embodiment, mod 150 generates a topic list comprising several keywords extracted from the contents of various messages in the email thread.

Mod 152 identifies relationships of thread participants to the topics generated by mod 150. A non-limiting basis for determining that a relationship exists between a participant and a topic is if mod 150 generated the topic based on a message contributed by the participant; another non-limiting basis is if a reference to both the participant and the topic is made in the same message (e.g., “Jack, would you please follow up regarding the ecloud landing problem?”).

Mod 154 generates and displays a participant-topic relationship graph (or simply “graph”) that comprises a visual representation linking one or more participants with one or more topics in the thread. In a non-limiting embodiment, participants may be represented by participant nodes that appear in the middle of the graph, with organizational relationship information shown to one side (e.g., to the left), topics represented as topic nodes shown to the other side (e.g., to the right), and connections (e.g., lines, edges) shown linking participant nodes with topic nodes where a participant-topic relationship exists.

Mod 156 generates and displays summary information based on the contents of one or more messages in the thread. The summary information may provide additional information regarding a relationship between a participant and a topic. In a non-limiting embodiment, the summary information may be displayed beside the name of the corresponding participant.

Mod 158 generates and displays attitude information based on the contents of one or more messages in the thread. Attitude information can indicate, for example but without limitation, a positive attitude or a negative attitude of a participant toward a topic, as determined based on keywords extracted from one or more messages contributed by the participant. In a non-limiting embodiment, attitude information can be represented visually, e.g., as a smiling or frowning emoticon, beside the summary information generated by mod 156.

Mod 160 generates and displays a list of related responses in other conversations. In a non-limiting embodiment, mod 160 generates topics based on messages in the user's inbox that are not part of the same thread and determines that a message is a related response based on, e.g., one or more of a topic extracted from the message and the identity of the sender.

Mod 162 filters the graph generated by mod 154 to show only one topic and the relationships of participants to the topic, e.g., removing participant nodes for participants that do not have a relationship to the topic.

Mod 164 uses color to distinguish between, e.g., the first message in a thread that includes the topic and subsequent messages in the same thread that include the topic.

Mod 166 visually represents topic prevalence using size, e.g., varying the sizes of topic nodes such that a topic node for a topic extracted from a larger number of messages appears larger than a topic node for a topic extracted from a smaller number of messages. For example, a topic node for a topic extracted from one message appears smaller than a topic node for a topic extracted from three messages, which in turn appears smaller than a topic node for a topic extracted from five messages.

In a non-limiting example, ten topics are extracted from a thread consisting of thirty messages; if the topic “ecloud” is extracted from the largest number of messages, mod 166 causes the node for “ecloud” to appear larger than each of the nine topic nodes respectively corresponding to the other nine topics.

Mod 168 visually represents the strength of relationships of participants to topics, e.g., varying the thickness of lines connecting various participants to various topics. In a non-limiting example, four participants are connected to the topic “Import,” which is extracted from six messages; if a user Andy contributed three messages, the largest number of messages contributed by a participant connected with the topic “Import,” then the line connecting Andy's participant node to the topic node for “Import” appears thicker than each of the three other lines respectively connecting the participant nodes for the other three participants to the same topic node.

Mod 170 provides additional response details, e.g., displaying additional details regarding messages that include the topic when a user clicks on the summary information displayed by mod 156 or the related response information displayed by mod 160.

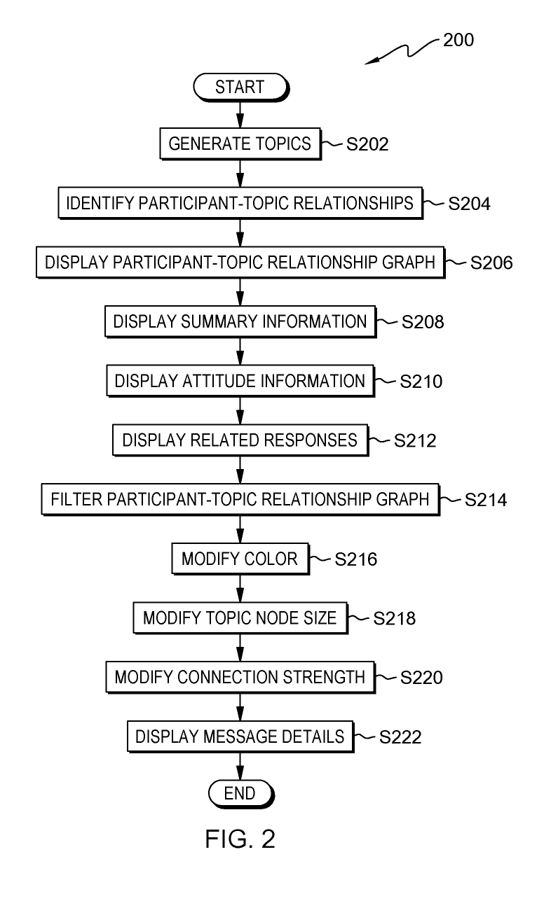

FIG. 2 is a flowchart 200 depicting operational steps S202-S222 of a topic-based team analytics method, in accordance with an embodiment of the present invention. It should be noted that operational steps S202-S222 need not be performed in the order described herein, and not all embodiments perform all operational steps S202-S222.

In operation S202, mod 150 generates topics based on the contents of messages in a thread.

In operation S204, mod 152 identifies relationships of thread participants to the topics generated by mod 150.

In operation S206, mod 154 generates and displays a participant-topic relationship graph visually representing the relationships of the thread participants to the topics.

In operation S208, responsive to a user input, e.g., a click on an edge connecting a participant node with a topic node, mod 156 generates and displays summary information based on the contents of one or more messages that demonstrate the relationship represented by the edge.

In operation S210, mod 158 determines an attitude of the participant represented by the participant node, e.g., based on extracting keywords from messages that the participant contributed to the thread. Mod 158 displays a visual representation of the attitude.

In operation S212, mod 160 generates a list of related responses in other threads. Mod 160 displays the list of related responses.

In operation S214, mod 162 filters the participant-topic relationship graph so that only one topic node and participant nodes connected to the one topic node are displayed. For example, mod 162 filters the participant-topic relationship graph responsive to the user clicking on the topic node.

In operation S216, mod 164 modifies a font color of displayed summary information that corresponds to a first message in the thread from which the topic was extracted.

In operation S218, mod 166 modifies the size of the displayed topic node based on the number of messages from which the topic was extracted. Alternatively, if operation S214 has been omitted or the user has made another selection restoring the participant-topic relationship graph to an unfiltered state, mod 166 modifies the sizes of various displayed topic nodes based on the number of messages from which the topics were respectively extracted, such that smaller nodes represent topics extracted from a smaller number or messages and larger nodes represent topics extracted from a larger number of messages.

In operation S220, mod 168 modifies the thickness of the displayed edges connecting one or more participant nodes to one or more topic nodes based on the strength of the respective connections between the represented participants and topics.

In operation S222, mod 170 displays additional message details, e.g., responsive to the user clicking on the summary information displayed by mod 156.

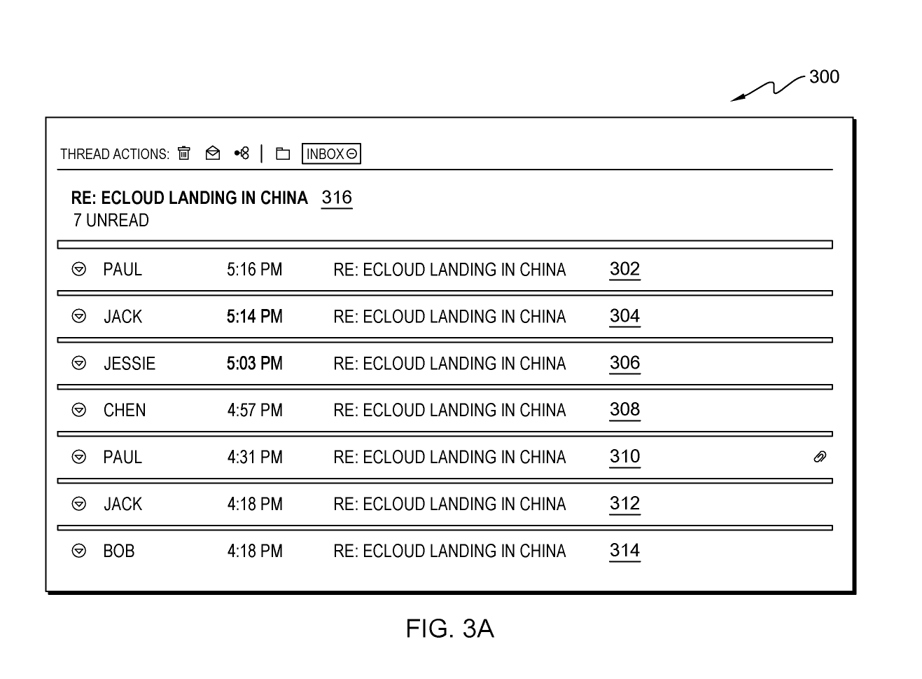

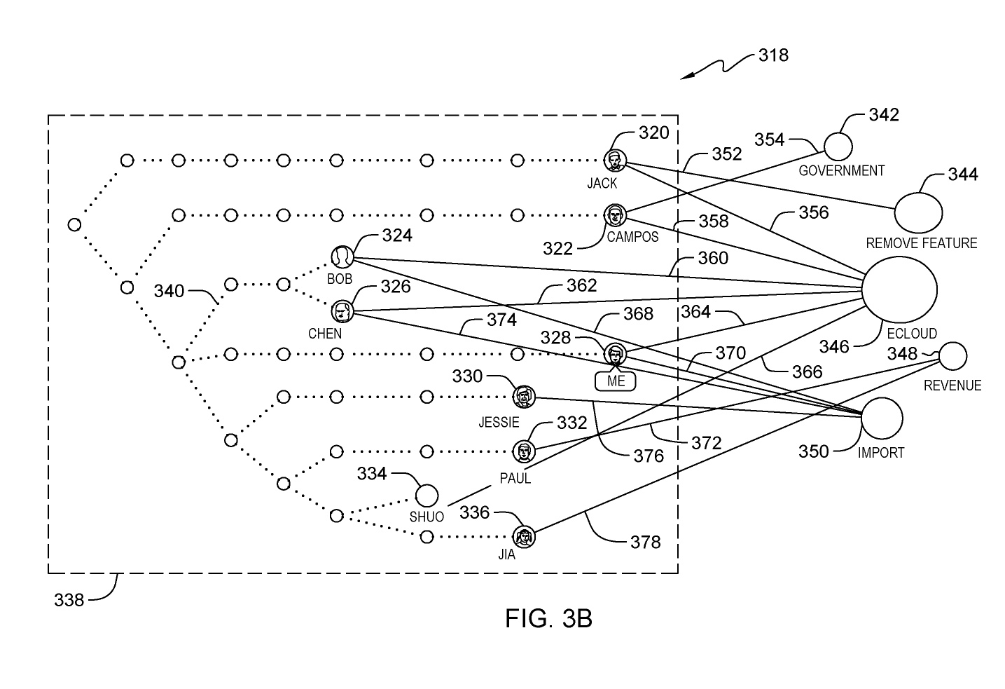

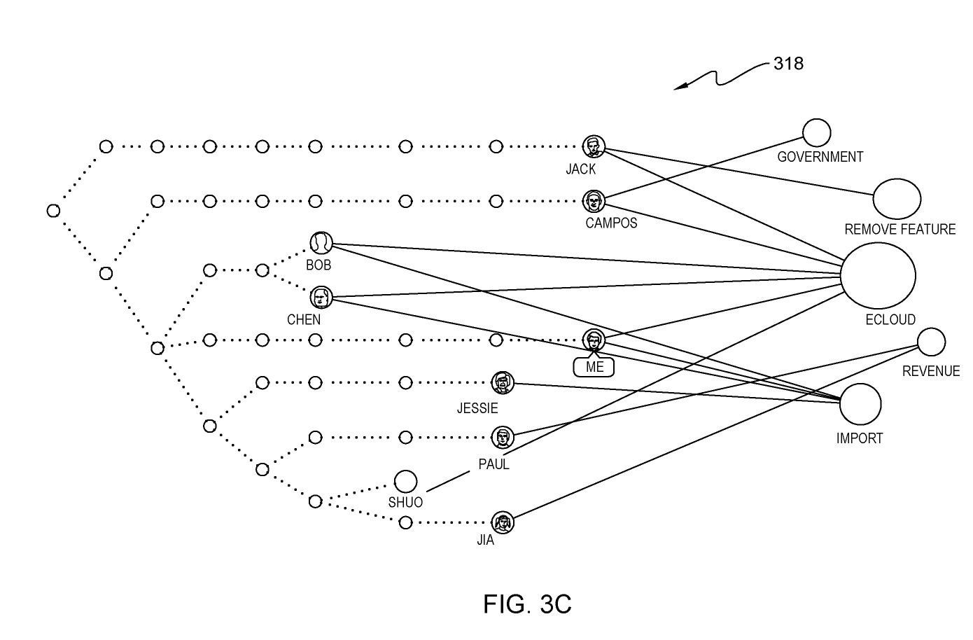

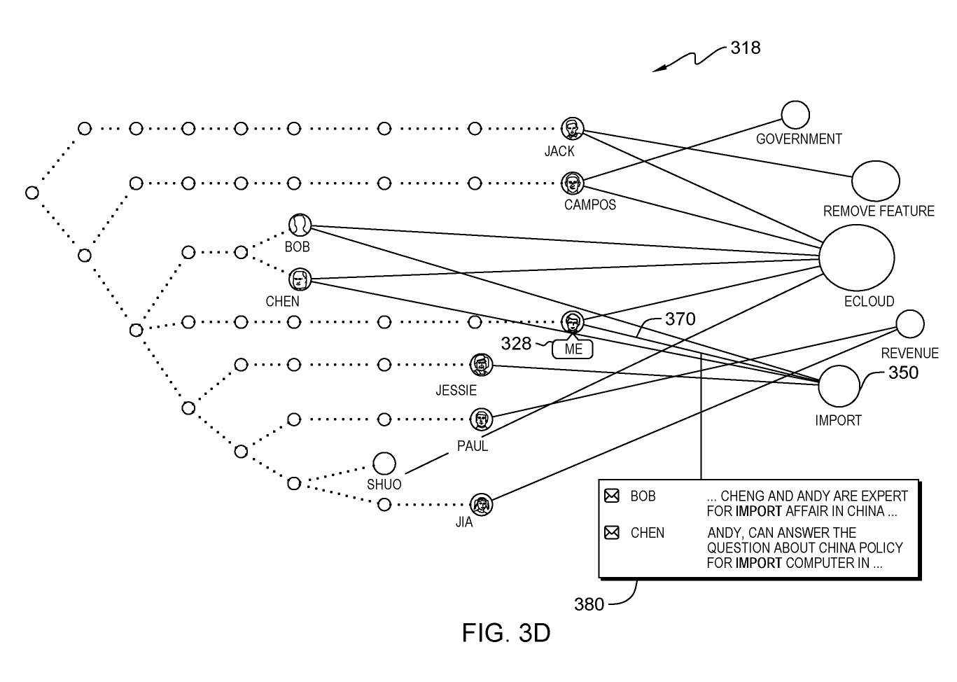

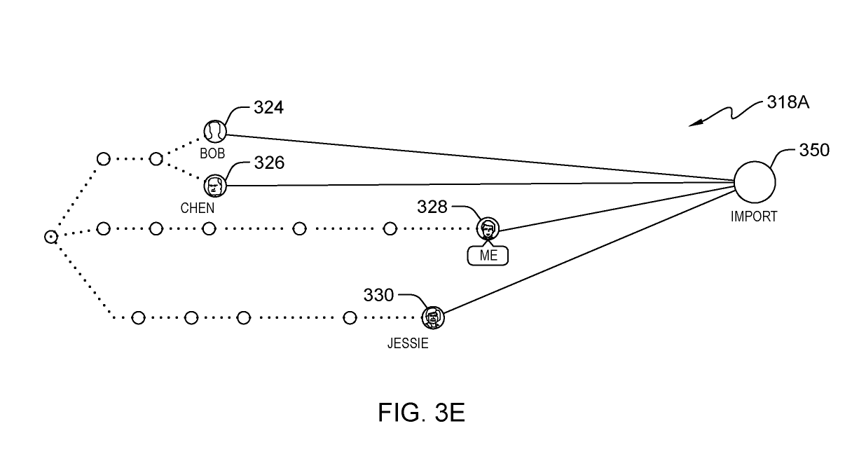

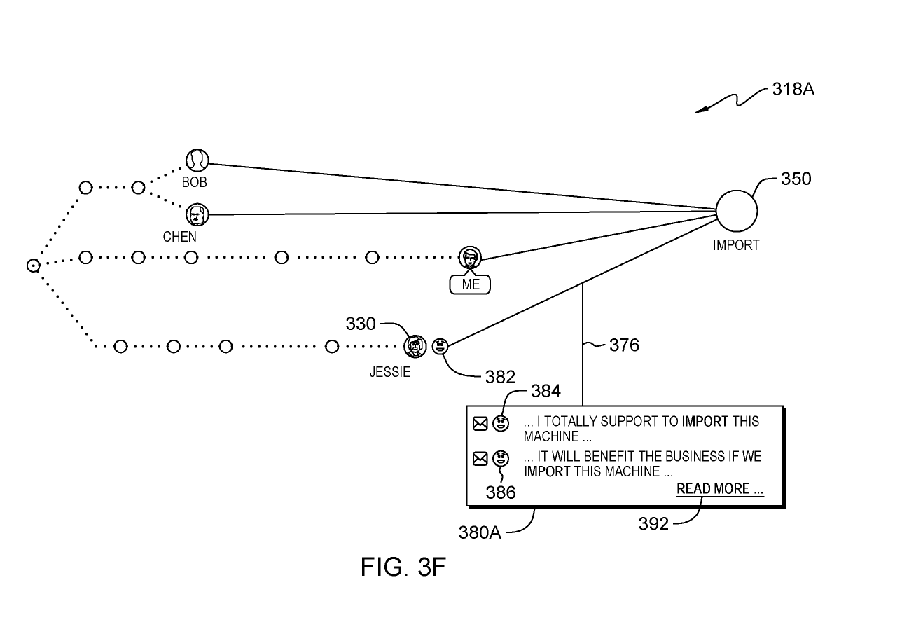

FIGS. 3A-E are diagrams illustrating a non-limiting example of topic-based team analytics, in accordance with an embodiment of present invention.

FIG. 3A shows a screen view of email inbox 300 belonging to Andy, the global logistics manager at an international technology company. On any given day, Andy may receive hundreds of email messages. Inbox 300 shows seven messages 302-314 with the subject line, “Re: ecloud landing in China.” Andy does not know any of the senders except for Chen. Andy seldom interacts with the Cloud business unit at his company.

If Andy clicks on any of messages 302-314, he finds that it is part of a much longer thread 316 consisting of more than thirty messages, Andy was first added to the thread by Bob.

FIG. 3B shows a first view of graph 318 generated by mod 154 of FIG. 1B when Andy opens thread 316 and selects an option to view a participant-topic graph, i.e., graph 318. For example, Andy may click on a ‘Thread Analytics’ button (not shown) that is made available by email component 108 of FIG. 1A. Graph 318 shows participant nodes 320-336 representing participants in thread 316 and organizational information 338, which shows that participant node 324 (“Bob”) and participant node 326 (“Chen”) share a common business unit, represented by branch 340 (e.g., a branch representing the ‘Supply Chain’ business unit, whereas other branches may represent a ‘Cloud’ business unit or a ‘Finance’ business unit).

Graph 318 also shows topic nodes 342-350 and edges 352-378 connecting topic nodes 342-350 to participant nodes 320-336. For example, edge 352 connects participant node 320 (“Jack”) to topic node 344 (“remove feature”) because the participant Jack has a relationship to the “remove feature” topic. Andy sees that his own participant node, participant node 328, is only connected with topic node 346 (“ecloud”) and topic node 350 (“Import”).

FIG. 3C shows a second view of graph 318, unobscured by reference numbers, in the interest of clarity.

FIG. 3D shows graph 318 with summary information 380 that appears when Andy clicks on edge 370 between participant node 328 and topic node 350.

FIG. 3E shows a graph 318A, a filtered version of graph 318, that appears when Andy clicks on topic node 350, in order to focus on the ‘Import’ topic. Only participant nodes connected to topic node 350 (i.e., participant nodes 324-330) appear.

FIG. 3F shows summary information 380A that appears when Andy clicks on edge 376 between participant node 330 (“Jessie”) and topic node 350. Andy does not know Jessie, but based on summary information 380A, and particularly attitude indicators 382-386 (showing a smiling emoticon) and message excerpts 388-390, that Jessie has a positive attitude toward the ‘Import’ topic. Option 392 also appears to allow Andy to view additional message details, e.g., additional message details generated by mod 170 of FIG. 1B.

FIG. 4 depicts a block diagram 400 of components of computing device 104 in computing environment 100, in accordance with illustrative embodiments of the present invention. It should be appreciated that FIG. 4 provides only an illustration of one implementation and does not imply any limitations with regard to the environments in which different embodiments may be implemented. Many modifications to the depicted environment may be made.

Computing device 104 includes communications fabric 402, which provides communications between computer processor(s) 404, memory 406, persistent storage 408, communications unit 410, and input/output (I/O) interface(s) 412, and cache 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) and cache memory 414. In general, memory 406 can include any suitable volatile or non-volatile computer readable storage media. Cache 414 is a fast memory that enhances the performance of computer processor(s) 404 by holding recently accessed data, and data near accessed data, from memory 406.

Program instructions and data used to practice embodiments of the invention, referred to collectively as component(s) 416, are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive can be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. Communications unit 410 can include one or more network interface cards. Communications unit 410 can provide communications through the use of either or both physical and wireless communications links. Component(s) 416 can be downloaded to persistent storage 408 through communications unit 410.

I/O interface(s) 412 allows for input and output of data with other devices that may be connected to computing device 104. For example, I/O interface 412 can provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., component(s) 416, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a touchscreen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1-7. (canceled)

8. A computer program product for topic-based team analytics, the computer program product comprising:
one or more computer readable storage media and program instructions stored on the one or more computer readable storage media, the program instructions comprising:
program instructions to extract a list of topics based on a thread;
program instructions to identify one or more participants with a relationship to one or more topics of the list of topics; and
program instructions to generate a graph of the list of topics, the one or more participants, and relationships of the one or more participants to the one or more topics, wherein the one or more participants are represented as participant nodes of the graph and the one or more topics are represented as topic nodes of the graph, and wherein the relationships of the one or more participants to the one or more topics are represented as one or more edges connecting participant nodes with topic nodes.

9. The computer program product of claim 8, further comprising:
program instructions to generate summary information demonstrating a relationship of a participant to a topic; and
program instructions to display, responsive to a user interaction with a participant node representing the participant or a topic node representing the topic, the summary information.

10. The computer program product of claim 8, further comprising:
program instructions to generate attitude information associated with a participant; and
program instructions to display a visual representation of the attitude information.

11. The computer program product of claim 8, further comprising:
program instructions to generate a list of related messages in additional threads; and
program instructions to display the list of related messages.

12. The computer program product of claim 8, further comprising:
program instructions to receive a user instruction to filter the graph;
program instructions to filter the graph to generate a filtered graph comprising one topic node; and
program instructions to display the filtered graph.

13. The computer program product of claim 8, wherein the one or more edges vary in thickness based on relationship strength.

14. The computer program product of claim 8, wherein the one or more topic nodes vary in size based on topic prevalence.

15. A computer system for topic-based team analytics, the computer system comprising:
one or more processors;
one or more computer readable storage media; and
program instructions stored on the one or more computer readable storage media for execution by at least one of the one or more processors, the program instructions comprising:
program instructions to extract a list of topics based on a thread;
program instructions to identify one or more participants with a relationship to one or more topics of the list of topics; and
program instructions to generate a graph of the list of topics, the one or more participants, and relationships of the one or more participants to the one or more topics, wherein the one or more participants are represented as participant nodes of the graph and the one or more topics are represented as topic nodes of the graph, and wherein the relationships of the one or more participants to the one or more topics are represented as one or more edges connecting participant nodes with topic nodes.

16. The computer system of claim 15, further comprising:
program instructions to generate summary information demonstrating a relationship of a participant to a topic; and
program instructions to display, responsive to a user interaction with a participant node representing the participant or a topic node representing the topic, the summary information.

17. The computer system of claim 15, further comprising:
program instructions to generate attitude information associated with a participant; and
program instructions to display a visual representation of the attitude information.

18. The computer system of claim 15, further comprising:
program instructions to generate a list of related messages in additional threads; and
program instructions to display the list of related messages.

19. The computer system of claim 15, further comprising:
program instructions to receive a user instruction to filter the graph;
program instructions to filter the graph to generate a filtered graph comprising one topic node; and
program instructions to display the filtered graph.

20. The computer system of claim 15, wherein the one or more edges vary in thickness based on relationship strength.
